(19) United States
(12) Patent Application Publication
(10) Pub. No.: US 2014/0061964 A1
(43) Pub. Date: Mar. 6, 2014

(54) Method for Manufacturing Gas Permeable Composite Foam Pad

(71) Applicants: Shih-Kan Liang, Taichung City (TW); Ya-Ting Hou, Taichung City (TW)

(72) Inventors: Shih-Kan Liang, Taichung City (TW); Ya-Ting Hou, Taichung City (TW)

(21) Appl. No.: 13/596,178

(22) Filed: Aug. 28, 2012

(51) Int. Cl. B29C 44/12

(52) U.S. Cl. 264/46.4

(57) ABSTRACT

A method includes refining and heating a foamable material with a petroleum resin, making the foamable material into particles by a granulating equipment, pouring the particles into a first die and heating the particles, placing at least one flexible fiber cloth layer into the first die to abut the particles, clamping the particles and the fiber cloth layer between the first die and a second die to proceed a vulcanization process so that the particles are foamed to form a composite foamed element which is combined with the fiber cloth layer to construct a gas permeable composite foam pad, and removing the gas permeable composite foam pad. Thus, the composite foamed element has a surface formed with a plurality of clearances which are located between the composite foamed element and the fiber cloth layer.

### BACKGROUND OF THE INVENTION

1. Field of the Invention

The present invention relates to a method for manufacturing a pad and, more particularly, to a method for manufacturing a pad available for shoes, sport or medical equipments, transport vehicles, household accessories and the like.

2. Description of the Related Art

A conventional shoe pad comprises a pad body and a fiber cloth layer bonded onto the pad body by glue or adhesive. However, the fiber cloth layer is combined with the pad body by glue or adhesive so that the conventional shoe pad may contain benzene or poisonous material, thereby easily causing an environmental pollution. In addition, the surface of the pad body does not have any vent hole so that the conventional shoe pad has a poor ventilating effect. Further, the conventional shoe pad cannot be cleaned easily and cannot be dried quickly. Further, the conventional shoe pad has a poor shock-absorbing function.

### BRIEF SUMMARY OF THE INVENTION

In accordance with the present invention, there is provided a method for manufacturing a gas permeable composite foam pad, comprising a step a) of refining and heating a foamable material with a petroleum resin at a temperature of about 90 to 120° C., a step b) of making the foamable material into particles by a granulating equipment, a step c) of pouring the particles into a first die and heating the particles at a foaming temperature of about 155 to 180° C., a step d) of placing at least one flexible fiber cloth layer into the first die to abut the particles, a step e) of clamping the particles and the fiber cloth layer between the first die and a second die to proceed a vulcanization process so that the particles are foamed to form a composite foamed element which is combined with the fiber cloth layer to construct a gas permeable composite foam pad, and a step f) of removing and cutting the gas permeable composite foam pad into a determined shape. In the step e), the composite foamed element is bonded onto the fiber cloth layer closely and solidly and has a surface formed with a plurality of clearances which are located between the composite foamed element and the fiber cloth layer.

Preferably, the foamable material is made of ethyl vinyl acetate (EVA), polyethylene (PE), ENGAGE, polyolefin elastomer (POE), rubber or plastics.

Preferably, the foamable material is cut by the granulating equipment into the particles with regular shapes.

Alternatively, the foamable material is cut by the granulating equipment into the particles with irregular shapes.

Preferably, the composite foamed element has two opposite faces each combined with a fiber cloth layer so that the composite foamed element is sandwiched between the two fiber cloth layers.

Preferably, the step f) further includes heating the gas permeable composite foam pad by an oven at a temperature of about 180 to 200° C., and pressurizing the gas permeable composite foam pad by a cold press so as to mold and shape the gas permeable composite foam pad.

Preferably, in the step f), the gas permeable composite foam pad is pressed by the cold press at a temperature of about 5° C. to an ambient temperature.

According to the primary advantage of the present invention, the composite foamed element is combined with the fiber cloth layer without needing any glue or adhesive so that the gas permeable composite foam pad does not contain any benzene or poisonous material so as to achieve an environmental protection purpose.

According to another advantage of the present invention, the composite foamed element has a plurality of clearances so that the gas permeable composite foam pad can drain water easily and quickly and can be cleaned conveniently.

According to a further advantage of the present invention, the composite foamed element has a plurality of clearances so that the gas permeable composite foam pad has an air ventilating effect and can be dried quickly.

According to a further advantage of the present invention, the composite foamed element has a plurality of clearances so that the gas permeable composite foam pad has a better shock-absorbing function.

According to a further advantage of the present invention, the gas permeable composite foam pad may be added with a recycled material to achieve a recycled purpose.

According to a further advantage of the present invention, the composite foamed element is added with mildew-proof and antibacterial agent so that the gas permeable composite foam pad has a mildew-proof and antibacterial function.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of a method for manufacturing a gas permeable composite foam pad in accordance with the preferred embodiment of the present invention.

FIGS. 2-4 are front cross-sectional views showing the method for manufacturing a gas permeable composite foam pad in accordance with the preferred embodiment of the present invention.

FIG. 5 is a front cross-sectional view of a gas permeable composite foam pad in accordance with the preferred embodiment of the present invention.

FIG. 6 is a top view of a composite foamed element of the gas permeable composite foam pad as shown in FIG. 5.

FIG. 7 is a cut view of the composite foamed element of the gas permeable composite foam pad as shown in FIG. 6.

FIG. 8 is an exploded perspective view of a gas permeable composite foam pad in accordance with the preferred embodiment of the present invention.

FIG. 9 is a schematic operational view of the gas permeable composite foam pad as shown in FIG. 5.

FIG. 10 is a locally enlarged view of the gas permeable composite foam pad as shown in FIG. 9.

FIG. 11 is a schematic operational view of the gas permeable composite foam pad as shown in FIG. 5.

FIG. 12 is a locally enlarged view of the gas permeable composite foam pad as shown in FIG. 11.

FIGS. 13-16 are front cross-sectional views showing the method for manufacturing a gas permeable composite foam pad in accordance with another preferred embodiment of the present invention.

FIG. 17 is a front cross-sectional view of a gas permeable composite foam pad in accordance with another preferred embodiment of the present invention.

FIG. 18 is an exploded perspective view of a gas permeable composite foam pad in accordance with another preferred embodiment of the present invention.

### DETAILED DESCRIPTION OF THE INVENTION

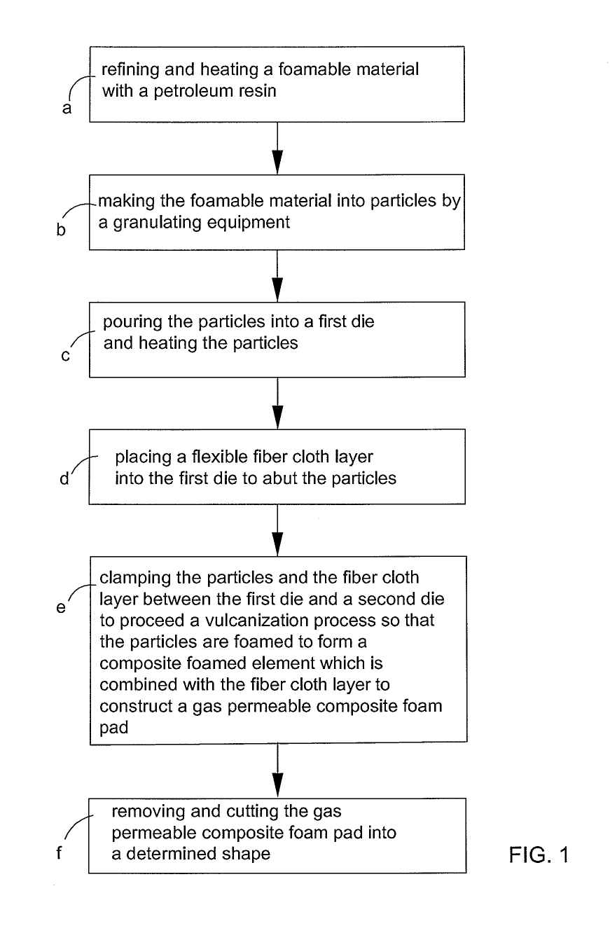

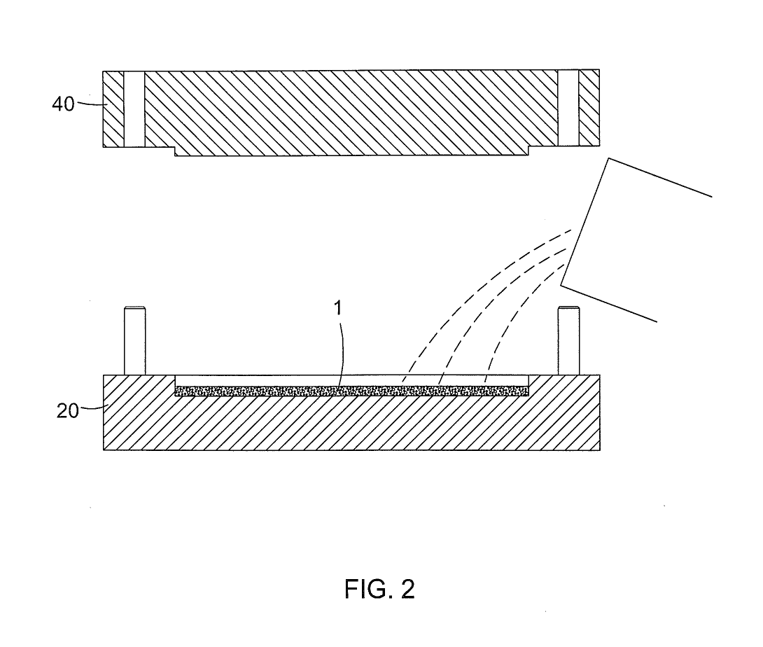

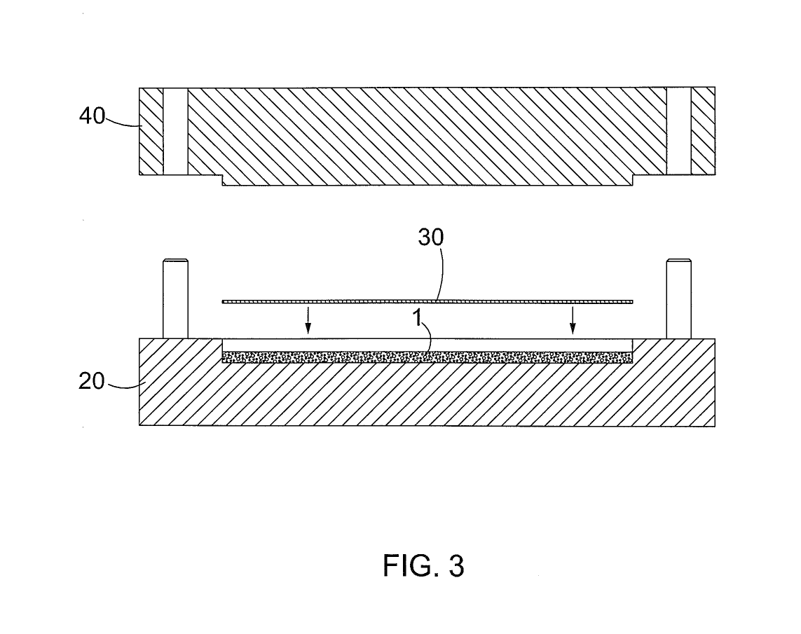

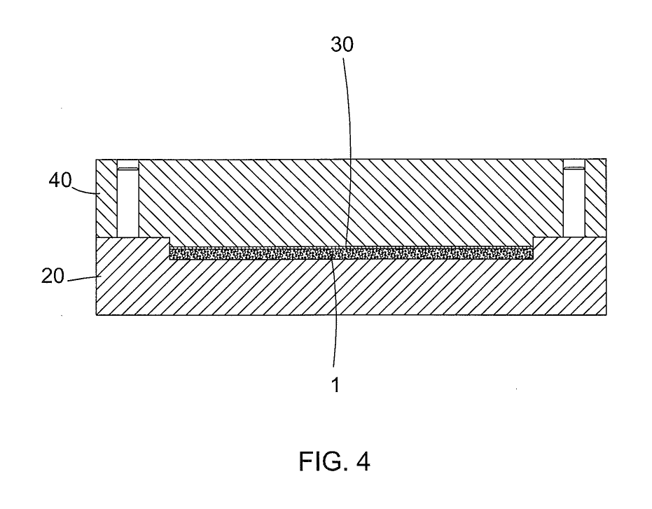

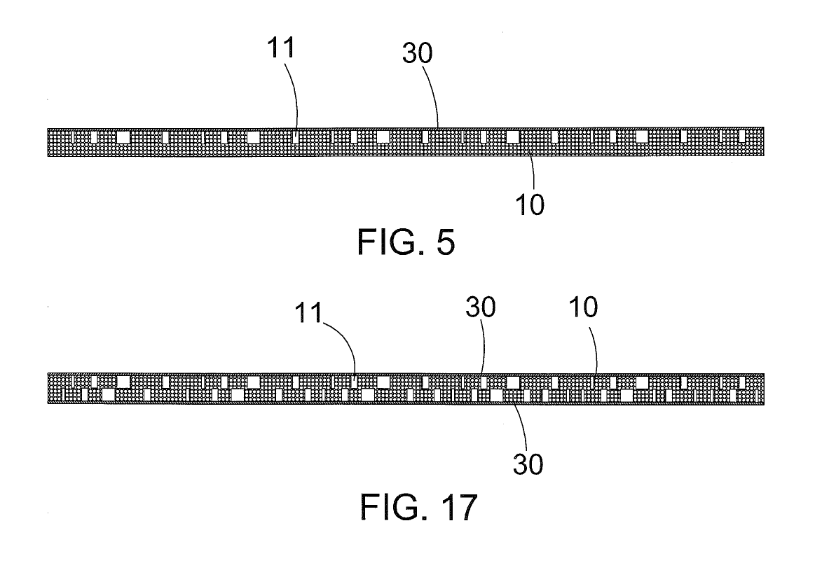

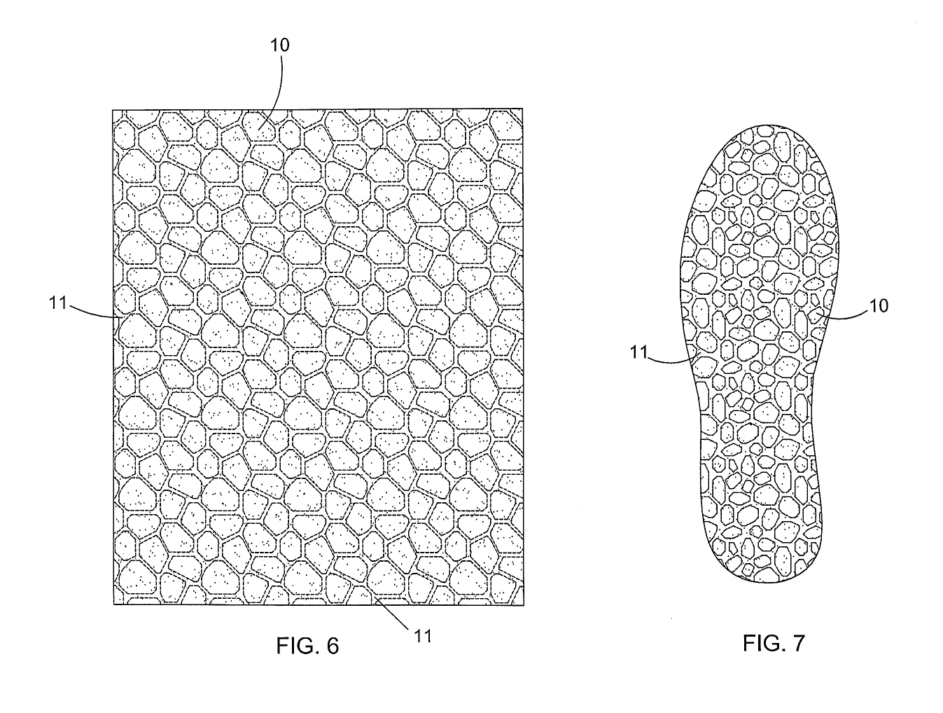

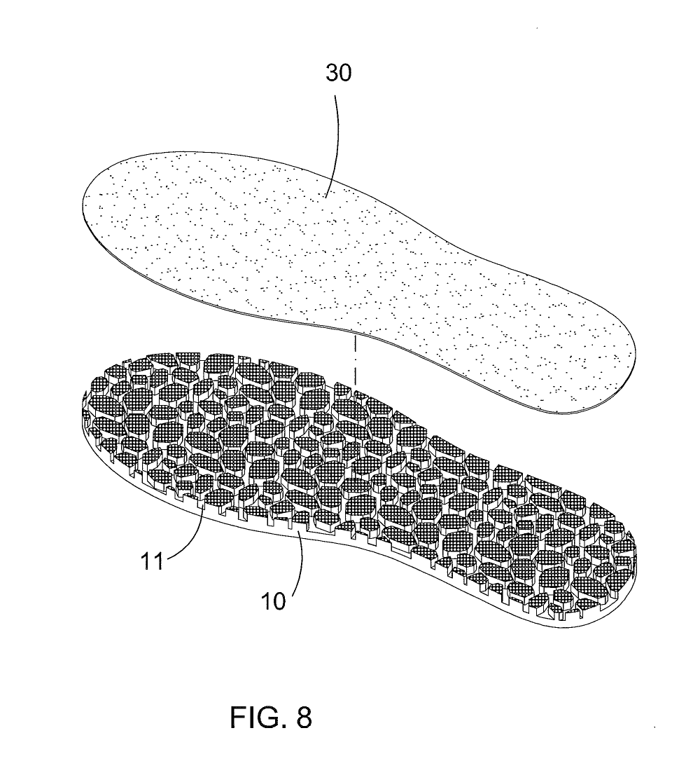

Referring to the drawings and initially to FIGS. 1-12, a method for manufacturing a gas permeable composite foam pad in accordance with the preferred embodiment of the present invention comprises a step a) of refining and heating a foamable material with a petroleum resin at a temperature of about 90 to 120° C., a step b) of making the foamable material into particles 1 by a granulating equipment, a step c) of pouring the particles 1 into a first die 20 and heating the particles 1 at a foaming temperature of about 155 to 180° C. as shown in FIG. 2, a step d) of placing a flexible fiber cloth layer 30 into the first die 20 as shown in FIG. 3 to abut the particles 1, a step e) of clamping the particles 1 and the fiber cloth layer 30 between the first die 20 and a second die 40 as shown in FIG. 4 to proceed a vulcanization process so that the particles 1 are foamed to form a composite foamed element 10 as shown in FIG. 6 which is combined with the fiber cloth layer 30 to construct a gas permeable composite foam pad as shown in FIG. 5, and a step f) of removing and cutting the gas permeable composite foam pad into a determined shape as shown in FIGS. 7 and 8.

In the step a), the foamable material is made of ethyl vinyl acetate (EVA), polyethylene (PE), ENGAGE, polyolefin elastomer (POE), rubber or plastics. In the step b), the foamable material is cut by the granulating equipment into the particles 1 with regular or irregular shapes. In the step e), the composite foamed element 10 is bonded onto the fiber cloth layer 30 closely and solidly and has a surface formed with a plurality of clearances 11 which are located between the composite foamed element 10 and the fiber cloth layer 30. The step f) further includes heating the gas permeable composite foam pad by an oven at a temperature of about 180 to 200° C., and pressurizing the gas permeable composite foam pad by a cold press so as to mold and shape the gas permeable composite foam pad. In the preferred embodiment of the present invention, the gas permeable composite foam pad is pressed by the cold press at a temperature of about 5° C. to an ambient temperature.

As shown in FIGS. 7 and 8, the gas permeable composite foam pad is cut into a shoe pad.

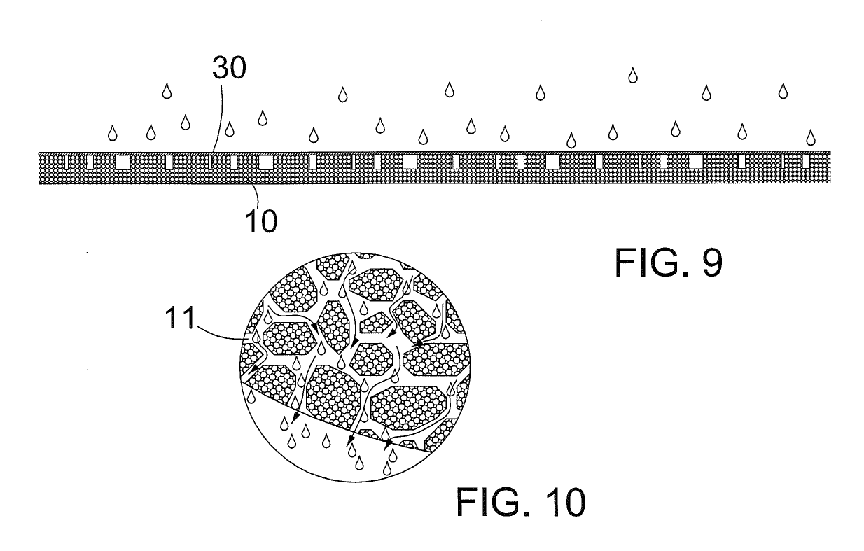

As shown in FIGS. 9 and 10, when the gas permeable composite foam pad is used, water on the fiber cloth layer 30 can flow through the clearances 11 between the composite foamed element 10 and the fiber cloth layer 30 so that the water is drained outward from the gas permeable composite foam pad easily and quickly.

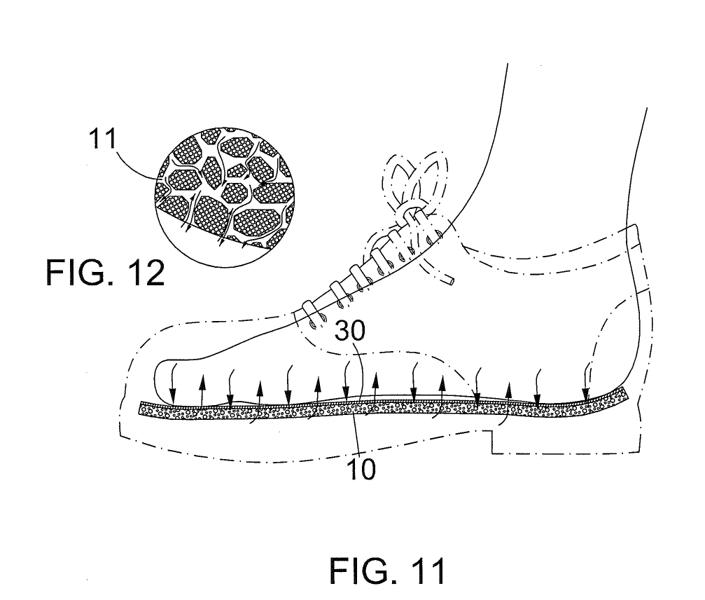

As shown in FIGS. 11 and 12, when a user wears the gas permeable composite foam pad, air on the fiber cloth layer 30 can flow through the clearances 11 between the composite foamed element 10 and the fiber cloth layer 30 so that the air circulates the gas permeable composite foam pad exactly and completely to achieve an air ventilating effect.

Accordingly, the composite foamed element 10 is combined with the fiber cloth layer 30 without needing any glue or adhesive so that the gas permeable composite foam pad does not contain any benzene or poisonous material so as to achieve an environmental protection purpose. In addition, the composite foamed element 10 has a plurality of clearances 11 so that the gas permeable composite foam pad can drain water easily and quickly and can be cleaned conveniently. Further, the composite foamed element 10 has a plurality of clearances 11 so that the gas permeable composite foam pad has an air ventilating effect and can be dried quickly. Further, the composite foamed element 10 has a plurality of clearances 11 so that the gas permeable composite foam pad has a better shock-absorbing function. Further, the gas permeable composite foam pad may be added with a recycled material to achieve a recycled purpose. Further, the composite foamed element 10 is added with mildew-proof and antibacterial agent so that the gas permeable composite foam pad has a mildew-proof and antibacterial function.

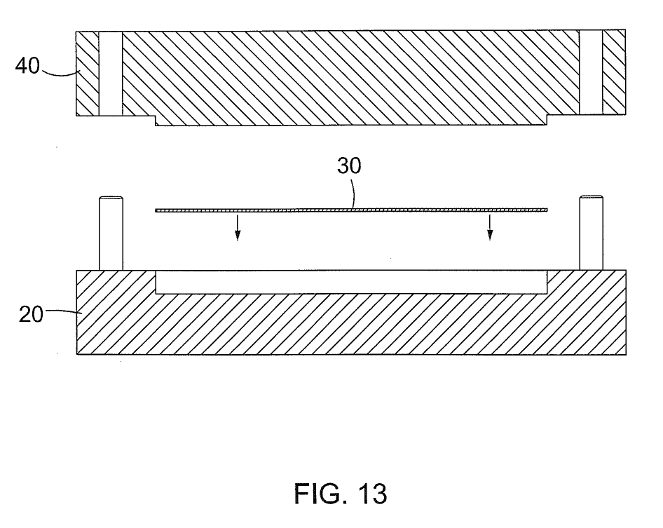

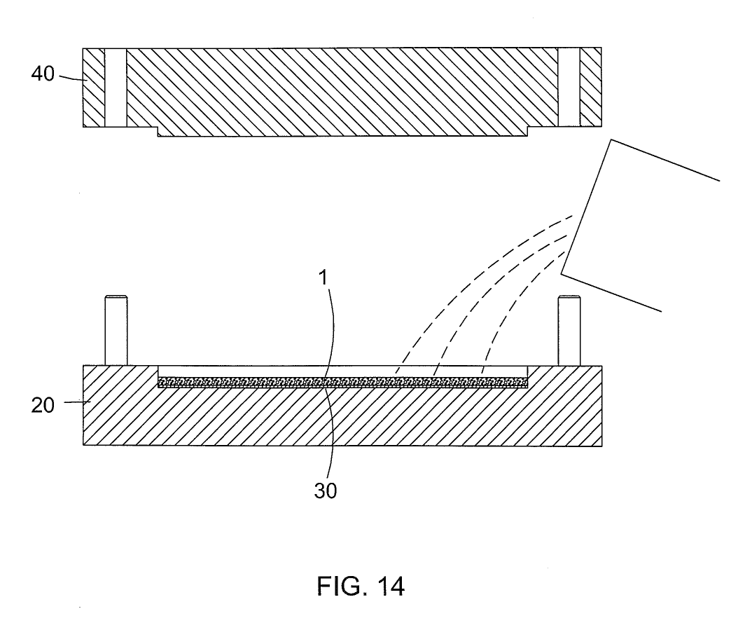

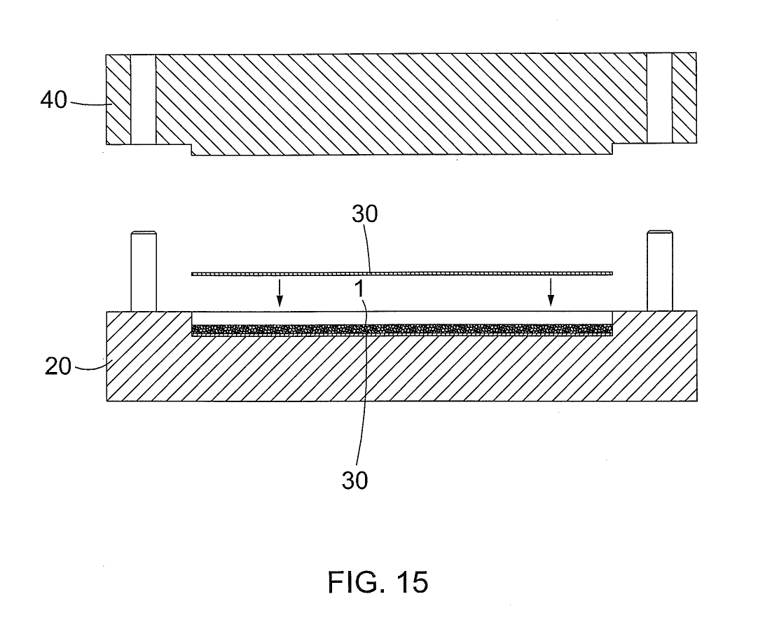

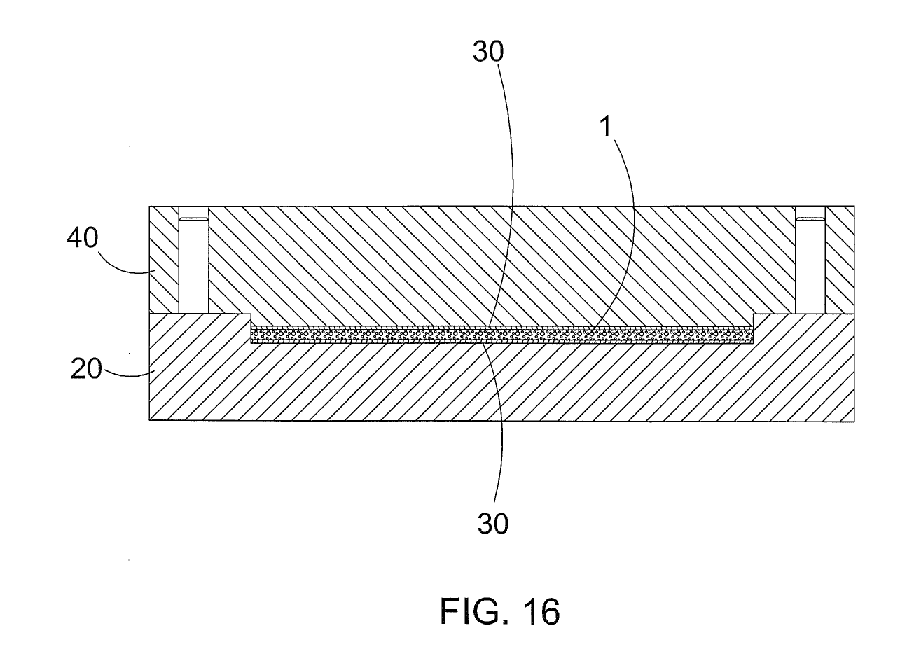

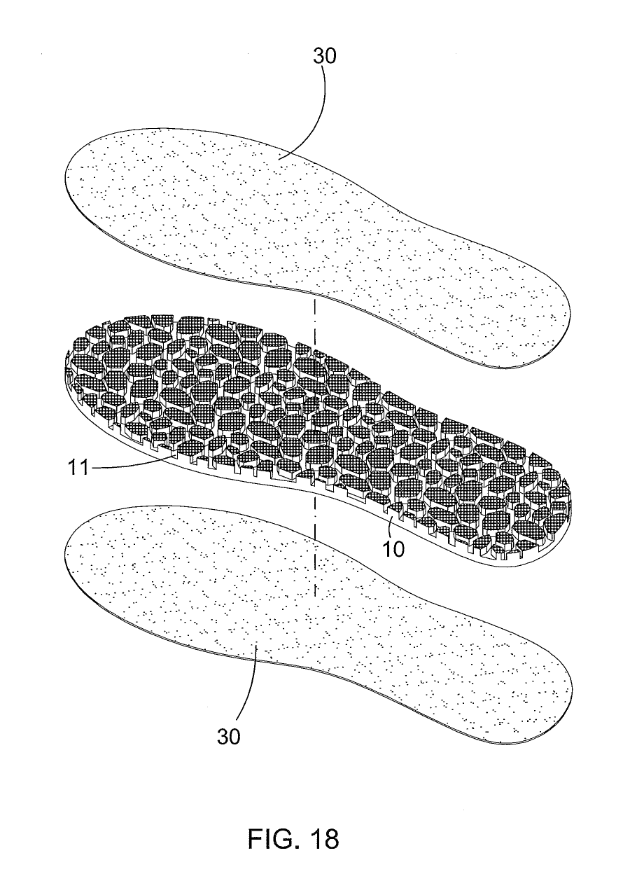

Referring to FIGS. 13-18, a method for manufacturing a gas permeable composite foam pad in accordance with another preferred embodiment of the present invention comprises a step a) of refining and heating a foamable material with a petroleum resin at a temperature of about 90 to 120° C., a step b) of making the foamable material into particles 1 by a granulating equipment, a step c) of placing a flexible fiber cloth layer 30 into a first die 20 as shown in FIG. 13, a step d) of pouring the particles 1 into the first die 20 to abut the fiber cloth layer 30 and heating the particles 1 at a foaming temperature of about 155 to 180° C. as shown in FIG. 14, a step e) of placing another flexible fiber cloth layer 30 into the first die 20 as shown in FIG. 15 to abut the particles 1, a step f) of clamping the particles 1 and the two fiber cloth layers 30 between the first die 20 and a second die 40 as shown in FIG. 16 to proceed a vulcanization process so that the particles 1 are foamed to form a composite foamed element 10 which is combined with the two fiber cloth layers 30 to construct a gas permeable composite foam pad as shown in FIG. 17, and a step g) of removing and cutting the gas permeable composite foam pad into a determined shape as shown in FIG. 18.

In the step a), the foamable material is made of ethyl vinyl acetate (EVA), polyethylene (PE), ENGAGE, polyolefin elastomer (POE), rubber or plastics. In the step b), the foamable material is cut by the granulating equipment into the particles 1 with regular or irregular shapes. In the step f), the composite foamed element 10 is bonded onto the two fiber cloth layers 30 closely and solidly and has a surface formed with a plurality of clearances 11 which are located between the composite foamed element 10 and one of the two fiber cloth layers 30. In the step f), the two fiber cloth layers 30 are combined with two opposite faces of the composite foamed element 10 so that the composite foamed element 10 is sandwiched between the two fiber cloth layers 30. The step g) further includes heating the gas permeable composite foam pad by an oven at a temperature of about 180 to 200° C., and pressurizing the gas permeable composite foam pad by a cold press so as to mold and shape the gas permeable composite foam pad. In the preferred embodiment of the present invention, the gas permeable composite foam pad is pressed by the cold press at a temperature of about 5° C. to an ambient temperature.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for manufacturing a gas permeable composite foam pad, comprising:
a step a) of refining and heating a foamable material with a petroleum resin at a temperature of about 90 to 120° C.;
a step b) of making the foamable material into particles by a granulating equipment;
a step c) of pouring the particles into a first die and heating the particles at a foaming temperature of about 155 to 180° C.;
a step d) of placing at least one flexible fiber cloth layer into the first die to abut the particles;
a step e) of clamping the particles and the fiber cloth layer between the first die and a second die to proceed a vulcanization process so that the particles are foamed to form a composite foamed element which is combined with the fiber cloth layer to construct a gas permeable composite foam pad; and
a step f) of removing and cutting the gas permeable composite foam pad into a determined shape;
wherein in the step e), the composite foamed element is bonded onto the fiber cloth layer closely and solidly and has a surface formed with a plurality of clearances which are located between the composite foamed element and the fiber cloth layer.

2. The method for manufacturing a gas permeable composite foam pad of claim 1, wherein the foamable material is made of ethyl vinyl acetate (EVA), polyethylene (PE), ENGAGE, polyolefin elastomer (POE), rubber or plastics.

3. The method for manufacturing a gas permeable composite foam pad of claim 1, wherein the foamable material is cut by the granulating equipment into the particles with regular shapes.

4. The method for manufacturing a gas permeable composite foam pad of claim 1, wherein the foamable material is cut by the granulating equipment into the particles with irregular shapes.

5. The method for manufacturing a gas permeable composite foam pad of claim 1, wherein the composite foamed element has two opposite faces each combined with a fiber cloth layer so that the composite foamed element is sandwiched between the two fiber cloth layers.

6. The method for manufacturing a gas permeable composite foam pad of claim 1, wherein the step f) further includes:
heating the gas permeable composite foam pad by an oven at a temperature of about 180 to 200° C.; and
pressurizing the gas permeable composite foam pad by a cold press so as to mold and shape the gas permeable composite foam pad.

7. The method for manufacturing a gas permeable composite foam pad of claim 6, wherein in the step f), the gas permeable composite foam pad is pressed by the cold press at a temperature of about 5° C. to an ambient temperature.
